(19) United States
(12) Patent Application Publication
(10) Pub. No.: US 2019/0323630 A1
(43) Pub. Date: Oct. 24, 2019

(54) HOLDING DEVICE FOR CABLES OR PIPES

(71) Applicant: EFCO Befestigungstechnik AG, Naenikon (CH)

(72) Inventor: Thomas DOPPELBAUER, Feldkirch (AT)

(21) Appl. No.: 15/961,400

(22) Filed: Apr. 24, 2018

(51) Int. Cl. F16L 3/10; F16L 3/13; F16L 3/137; F16L 3/12

(52) U.S. Cl. CPC F16L 3/1075; F16L 3/1226; F16L 3/137; F16L 3/13

(57) ABSTRACT

A holding device includes a holding foot for mounting the holding device on the ground, a fastening device arranged on the holding foot for fastening the cable or pipe on the holding foot, which has a first bracket and a second bracket lockable together by a bracket fastener, one free end of the first or second bracket being insertable into an opening of the bracket fastener. A joint connecting the second bracket to the holding foot is arranged in the second bracket, the second bracket carrying the opening of the bracket fastener, and the opening of the bracket fastener is movable over the free end of the first bracket by exerting pressure on the second bracket and is lockable by the bracket fastener. A clamping aid is arranged above the opening of the bracket fastener to provide a defined point of application for exerting pressure on the second bracket.

The invention concerns a holding device for cables or pipes.

Holding devices for cables and pipes may have flexible straps (cf. e.g. NL 7214307 A and WO 2015/193841 A1) or rigid brackets, one of which is arranged on the holding foot via a joint (cf. e.g. EP 2 141 397 A1).

A further holding device is shown in U.S. Pat. No. 5,349,799 A. The arcuate extensions 9 and 10 shown there serve only to increase the grippable surface of the holding device.

With known holding devices with brackets, the opening of the bracket fastener is arranged on the first bracket, and a free end of the second bracket arranged over the joint on the holding foot is inserted into the opening arranged on the first bracket. This is not always possible because the free end of the second bracket may accidentally move out of the way and the opening of the bracket fastener may be missed. Also the provision of a clamping aid arranged on the second bracket does not solve this problem, because the clamping aid must be distanced at least by that length from a free end of the second bracket, which is intended for insertion into the opening, since otherwise the clamping aid would prevent the free end of the second bracket from being inserted into the opening. The joint may also be located in the second bracket section, which then has a first section rigid with the holding foot, the joint and a second section articulated with the first section via the joint.

With known holding devices, the fastening device for the cable or pipe is designed as a clamp and arranged centrally at the holding foot. This makes it difficult to access the holding foot and thus to mount the holding foot on the ground.

In the case of a generic holding device, a stand is provided on the holding foot, which distances the fastening device for fastening the cable or pipe from the holding foot at a correct distance, so that the distance does not have to be selected by the fitter. It is known that the cable or pipe fastening device has a hook on the stand to which the cable or pipe is fastened by means of a fastening strap (like a cable tie) using a suitable tool. Because the fastening device is in the way of the holding foot, the hook has a passage opening that allows a tool to pass through to tighten a fastening means connecting the holding foot to the ground. When a setting tool is inserted into the passage opening, a view normal to the holding foot is not possible, which makes checking difficult. In addition, the setting tool must be correctly aligned after threading into the passage opening to contact the fastening means, which can only be done with difficulty without direct vision.

Generic holding devices are known where the cable or pipe fastening device has a hook on the stand to which the cable or pipe is fastened by means of a fastening strap (like a cable tie) using a suitable tool. Because the fastening device is in the way of the holding foot the hook has a passage opening that allows a tool to pass through to tighten a fastening means connecting the holding foot to the ground. A non-combustible safety strap, which is provided in addition to the fastening device, is also passed through the passage opening, and fastened with the holding device, together with mounting the holding device to the ground. During this process, the fitter must correctly align and hold the safety strap relative to the holding device, which is difficult to do, especially in mounting locations that are difficult to access.

One object of the invention is to provide a generic holding device where the cable or pipe can be attached more easily to the fastening device.

A further object of the invention is the provision of a generic holding device, where the accessibility of the holding foot and thus the mounting of the holding foot on the ground are improved.

A further object of the invention is the provision of a generic holding device, which simplifies the mounting of a non-combustible safety strap, which is provided in addition to the fastening device.

In one variant of the invention. It is provided that the second bracket connected to the holding foot via the joint carries the opening of the bracket fastener. The opening of the bracket fastener can be moved over the free end of the first bracket by applying pressure to the second bracket and locked by the bracket fastener. The pressure can be exerted in the area of the opening instead of in an area spaced from the free end of the second bracket, as is the case with the prior art. This makes it impossible to miss the free end of the first bracket—which is preferably arranged rigidly on the holding foot and designed rigidly. Above the opening of the bracket fastener (on the side of the bracket fastener facing away from the mounting foot) a clamping aid is arranged to provide a defined point of contact for exerting pressure on the second bracket.

The clamping aid is preferably designed as a wedge tapering in the direction of the second bracket.

Tho opening of the bracket fastener is preferably going through, so that the free end of the first bracket is movable through the opening of the bracket fastener arranged on the second bracket during locking, which allows an easy visual inspection. In addition, a larger diameter range of the cables or pipes to be fastened can be covered, as the opening of the bracket fastener is movable more or less far over the free end of the first bracket as required. It is also possible lo grip an end looking out of the opening with a tool and apply an additional force.

It is preferably provided that the joint, via which the second bracket is connected to the holding foot, is designed as an elastic or plastic joint. In such a joint, the pivotability of the second bracket is ensured by a local weakening of the cross-section of the second bracket in the area of the joint and the material properties of the bracket itself.

The bracket fastener can, for example, be designed in such a way that a rippled surface is arranged at the free end of the first bracket, which interacts with a locking lug arranged in the opening of the bracket fastener. Alternatively, at least one hole could also be arranged on the first bracket into which a pin arranged in the opening of the bracket fastener can be pressed. Alternatively, it could also be provided that the free end of the first bracket is designed without rippled surface, hole or the like, and that a limited movable element (e.g. wedge-shaped or spherical) is arranged in the opening of the bracket fastener, through which a self-locking locking is effected after the free end of the first bracket has been inserted into the opening.

In a variant of the invention it is provided that the stand is arranged at a lateral edge area of the holding foot so that the side of the holding foot facing away from the mounting side next to the stand is at least partially accessible in one direction normal to the side facing away from the mounting side. Accessibility shall be provided at least in the area of he side facing away from the mounting side via which the holding device is to be mounted to a ground. At least one fastening opening may be provided in this area for the passage of a fastening means to be anchored in the ground through the holding foot. Alternatively, the holding foot can be pierced during mounting using the fastening means. In contrast to the prior art, the stand does not have to have a passage opening that allows a setting tool to pass through to set a fastening means connecting the holding foot to the ground, which improves the stability of the stand.

Preferably, the holding device—apart from any non-combustible safety strap and fastening means that may be presort—is designed in one piece.

Preferably, the holding device—apart from any non-combustible safety strap and fastening means that may be present—is made of an electrically insulating material.

Preferably, the holding device—apart from any non-combustible safety strap and fastening means that may be present—consists of a (preferably electrically insulating) plastic.

In a variant of the invention, the holding device is provided with a device for attaching a non-combustible safety strap for the cable or pipe to the holding device in addition to the fastening device, irrespective of whether the holding device is mounted to the ground. The device for attaching the non-combustible safety strap to the holding device can be designed in many ways, e.g.:
at least one retaining clamp arranged on the holding device and/or
at least one channel arranged on the holding device and/or
at least one bonding point between the holding device and the safety strap

The safety strap is attached to the ground using preferably the fastening means by which the holding device is attached to the ground. Alternatively or additionally, a separate fastening means could of course also be provided for fastening the safety strap to the ground.

Embodiments of the invention are discussed on the basis of the figures. The figures show:

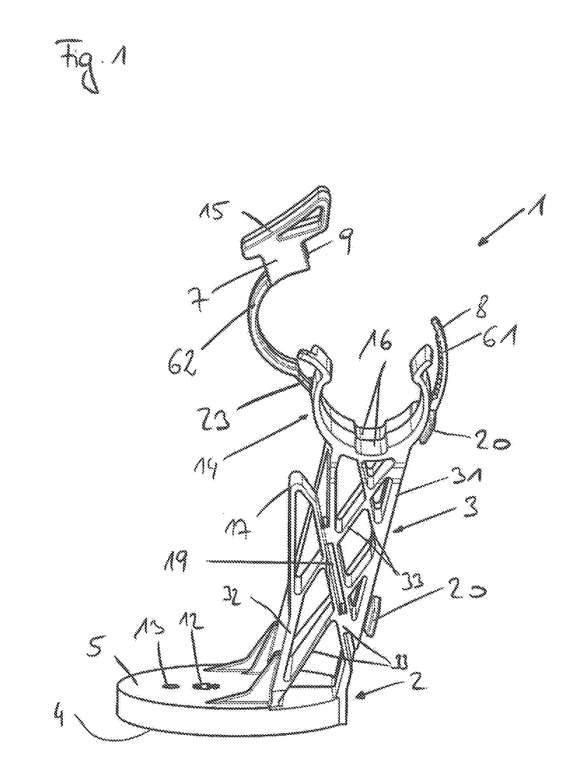

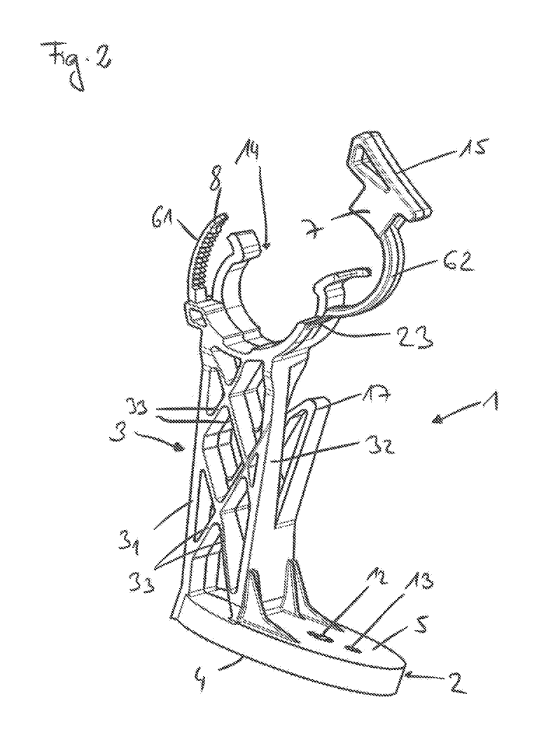

FIG. 1 an isometric view of a first design example

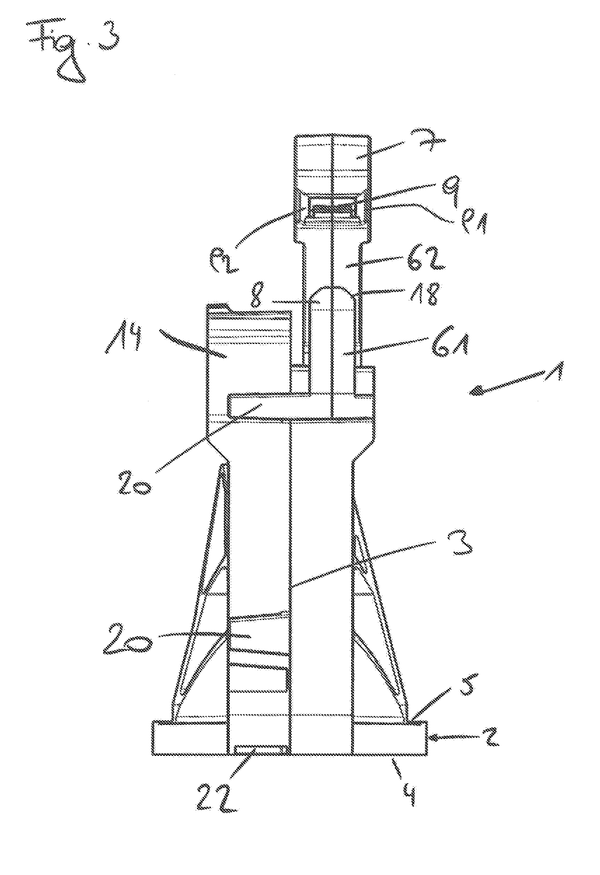

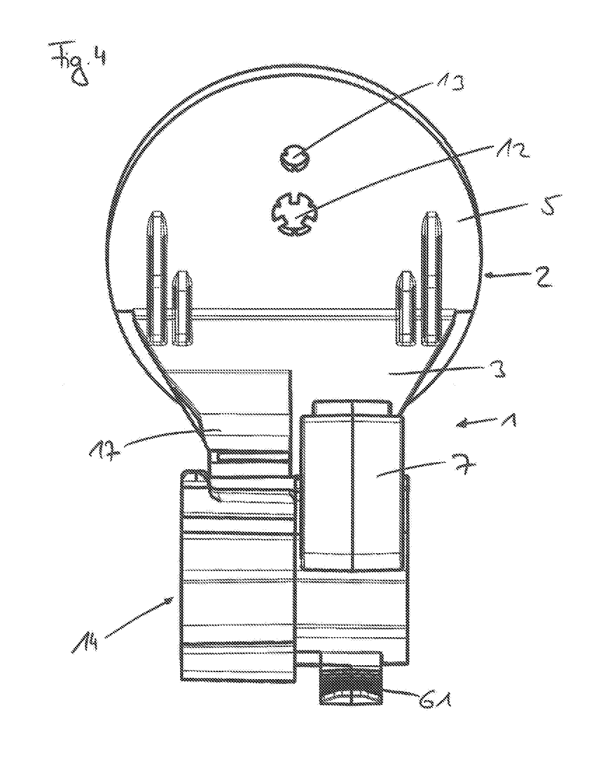

FIG. 2 another isometric view to FIG. 1

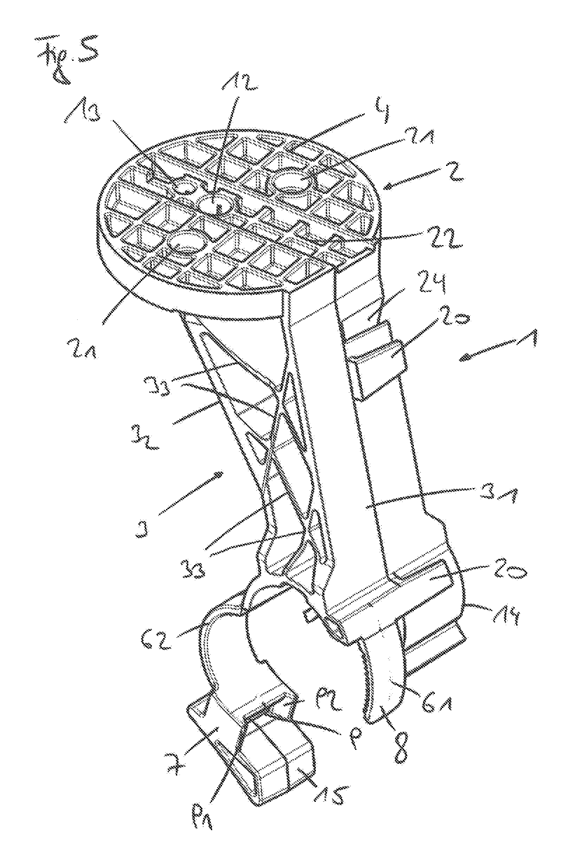

FIG. 3 a rear view to FIG. 1

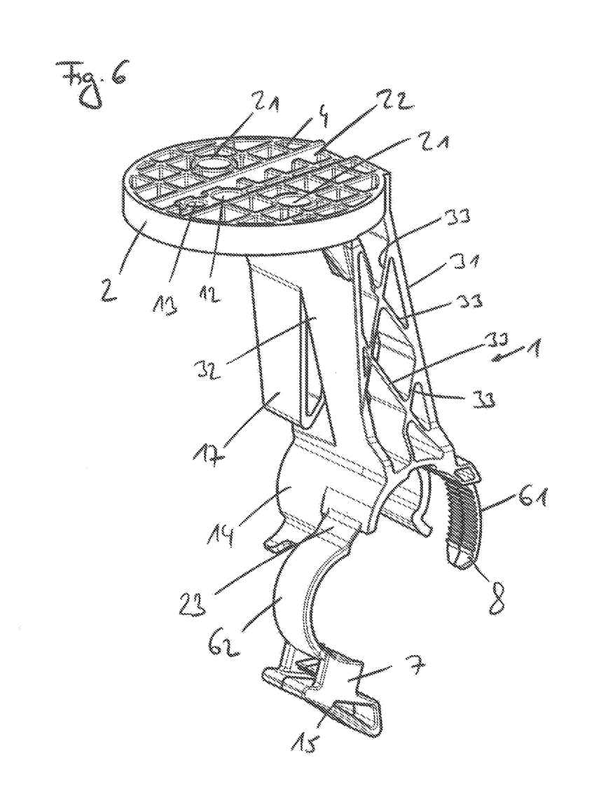

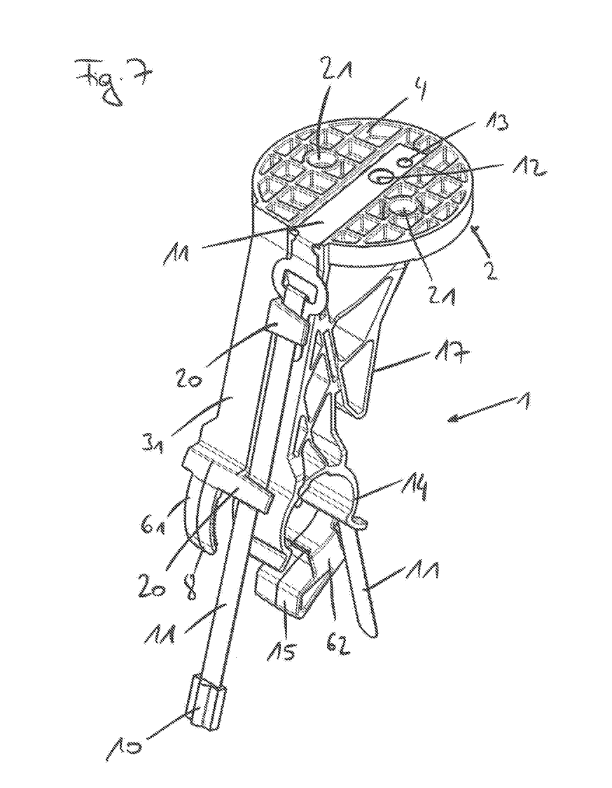

FIG. 4 a view of FIG. 1 in one direction approximately normal to the side of the mounting foot facing way from the mounting side

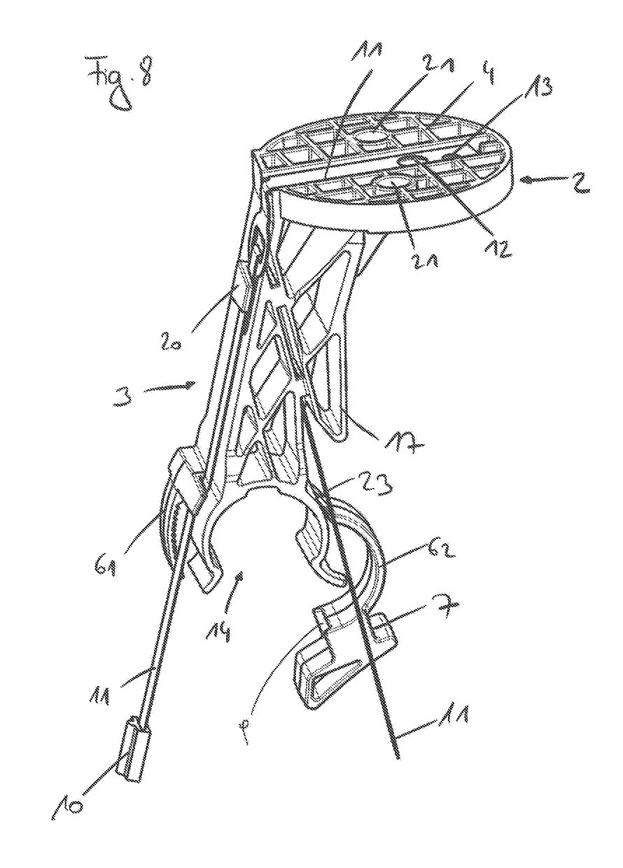

FIG. 5 another isometric view to FIG. 1

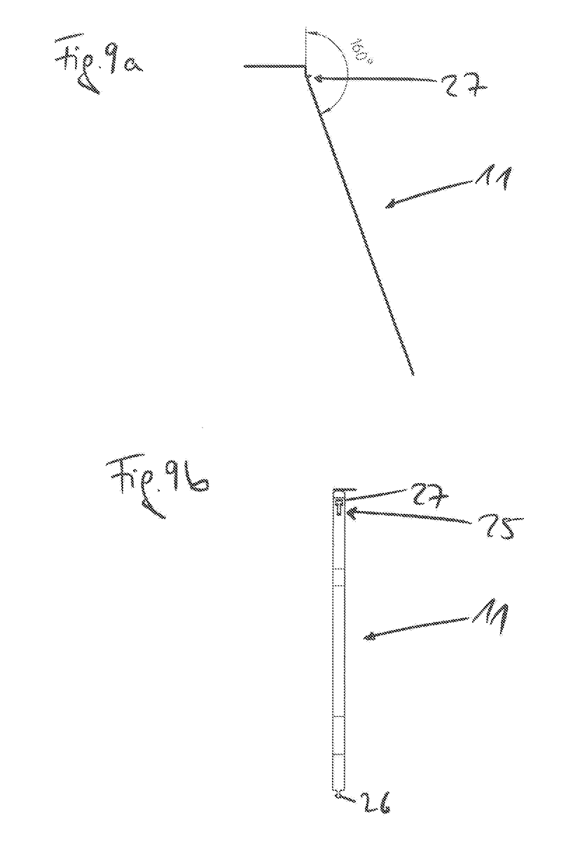

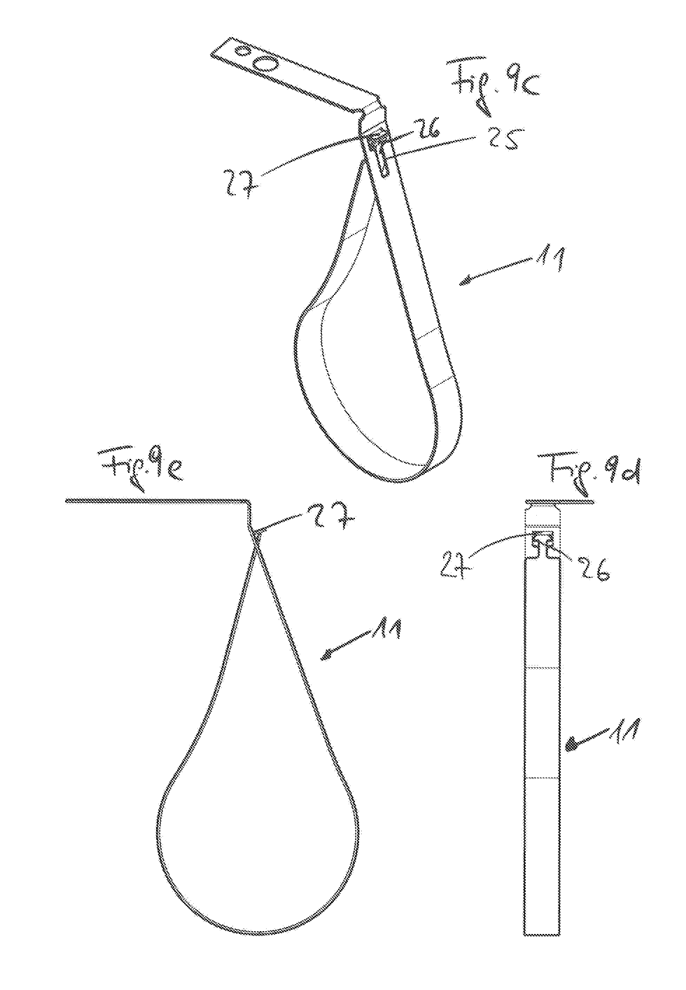

FIG. 6 another isometric view to FIG. 1

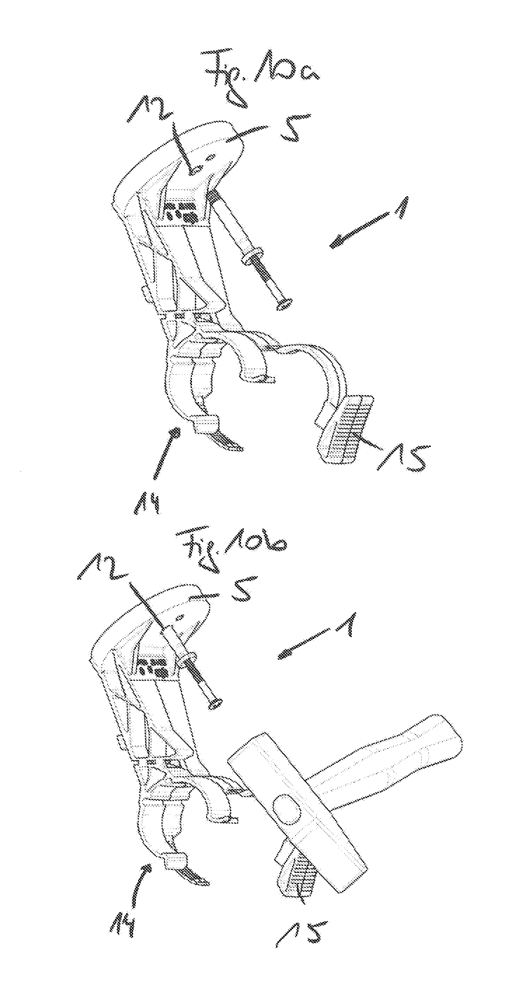

FIG. 7 another isometric view to FIG. 1 with inserted safety strap

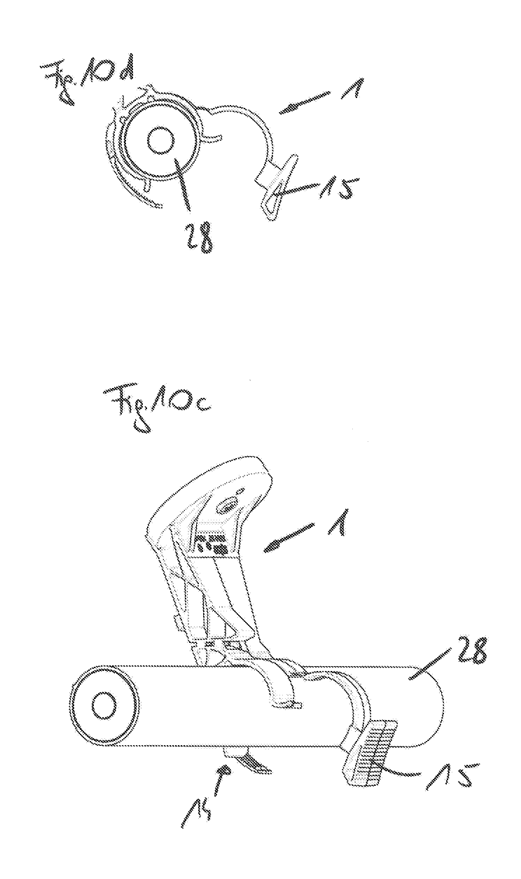

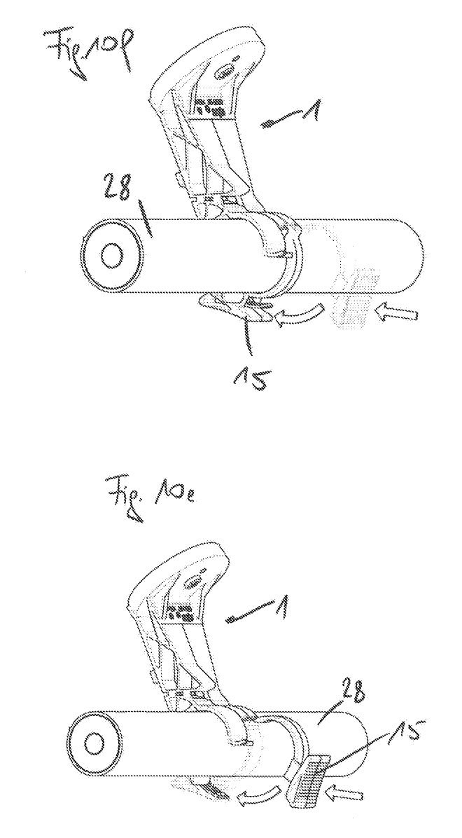

FIG. 8 another isometric view to FIG. 7

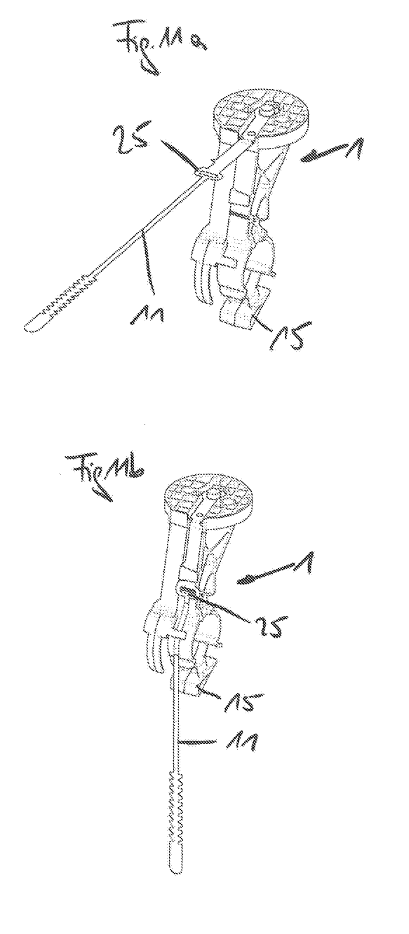

FIG. 9a-e another example of a non-combustible safety strap

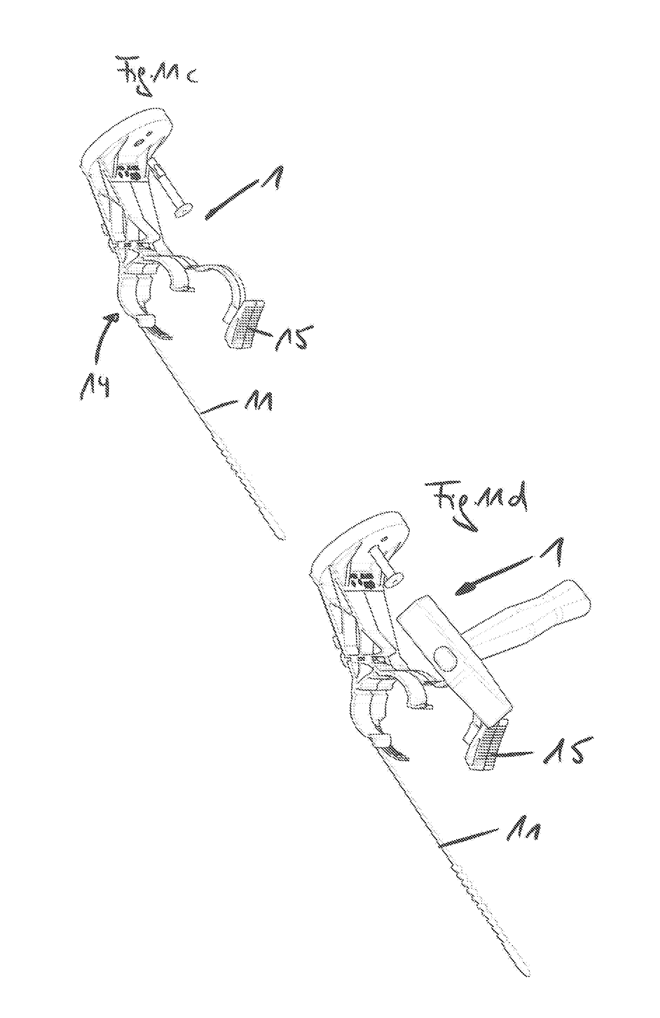

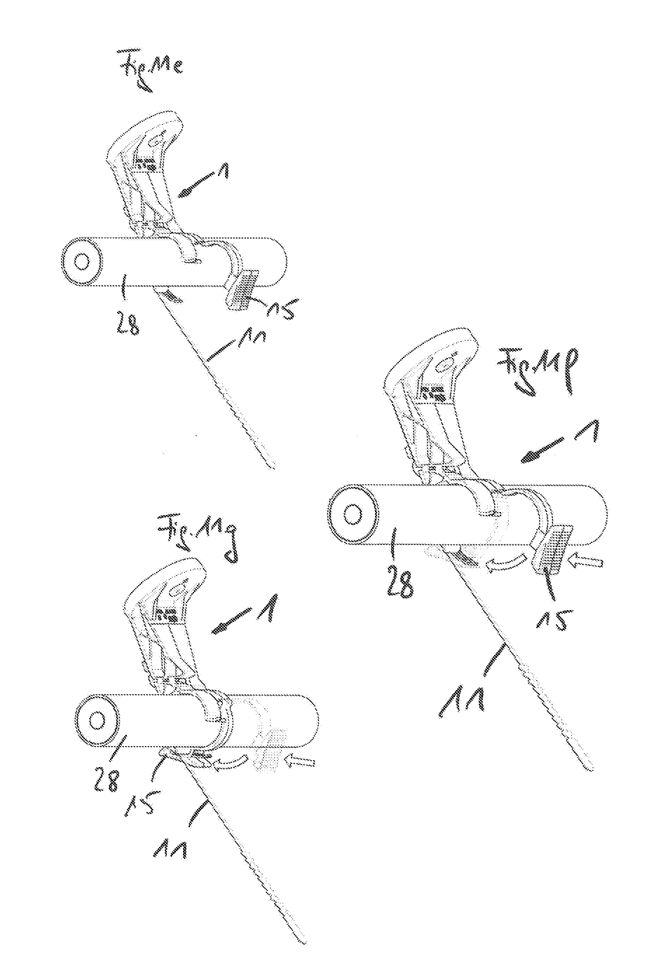

FIG. 10a-f an exemplary mounting process

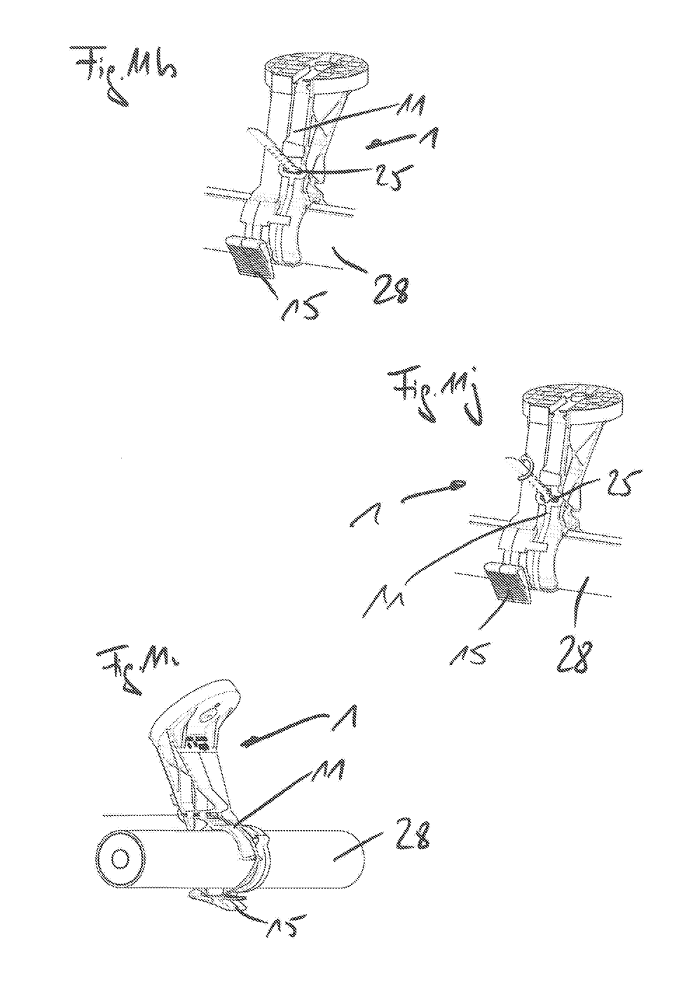

FIG. 11a-j another exemplary mounting procedure

FIG. 1 shows an embodiment of a holding device 1 for a cable or pipe 28, preferably for a so-called radiating cable (radiating cables are electrical leakage waveguides which are used as elongated antennas).

The holding device 1 has a holding foot 2 for mounting the holding device 1 to a ground (e.g. cable cup, ceiling or wall of a building—preferably a tunnel or shaft, etc.). Mounting is carried out with the mounting side 4 of the holding foot 2, e.g. by inserting a fastening means into the first and/or second fastening opening 12, 13 and connecting it to the ground. Examples of fastening means are screws, dowels (especially metal dowels), nails.

A fastening device is provided for fastening the cable or pipe 28 to the holding foot 2, whereby the fastening device is arranged on a side 5 of the holding foot 2 facing away from the mounting side 4.

The fastening device 2 has a stand 3 connected to the holding foot 2, which is arranged at a lateral edge area of the holding foot 2, so that the side 5 facing away from the mounting side 4 is at least partially accessible in a direction normal to side 5. This simplifies the mounting of holding device 1 to the ground, the selected fastening means can be inserted directly into the first and/or second fastening opening 12, 13 without further measures (in particular without the use of adapters), and can be connected to the ground with a suitable setting tool (e.g. hammer, screwdriver, air- or powder-driven tools. The setting tool is located next to the stand 3.

The stand 3 defines a fixed distance from the fastening device for the cable or pipe 28 to the mounting foot 2. Of course the distance of the cable or pipe to the ground can be increased by using spacers which are arranged between the mounting foot 2 and the ground (preferably connected to the mounting side 4 of the mounting foot 2). For correct positioning of such spacers, the mounting foot 2 can have at least one mounting 21 for at least one positioning pin arranged on the spacer.

As it can be clearly seen in FIG. 1 or 2, the stand 3 can be designed like a truss, in this way, sufficient rigidity can be achieved with low material input to ensure the load-bearing capacity of holding device 1. However, the stand 3 can be sufficiently elastic to be able to deform elastically along its entire length, for example in the event of pressure surges (these can occur, for example, due to a train passing through a tunnel), and then to be able to return to its initial position. In this way, the holding foot 2 and a fastening means connecting the holding foot 2 to the ground can be largely protected against dynamic forces. Point load peaks of the holding device 1—especially in the area of the fastening device for the cable or pipe 28 and in the area of the fastening means—as known from the prior art, can thus be avoided, since the dynamic forces are at least partially already absorbed in stand 3. The truss forms a spring-damper system. The stand 3 has two longitudinal struts 31, 32, which connect the mounting foot 2 with the fastening device. Several cross struts 33 run between these longitudinal struts 31, 32.

A further advantage of the accessibility of the side 5 of the holding foot 2, facing away from the mounting side 4, is the possibility of checking the safe mounting (e.g. visual inspection, checking with a torque wrench, etc.) and the possibility of any necessary reworking of the mounting. The easy accessibility of side 5 of holding foot 2 also offers advantages for demounting of the cable or pipe 28 from the ground that may be required without the need to disconnect the cable or pipe 28 from the fastening device for fastening the cable or pipe 28 to holding foot 2.

If the holding device 1 is mounted to the ground, the cable or pipe 28 can be pre-positioned on the holding device 1 using the pre-fixing 14. The cable or pipe 28 is clamped into the spring clamp 14 shown here with two resilient legs and can then be aligned axially and/or radially. In contrast to FIGS. 1 to 8, the pre-fixing 14 could also be of a different design, e.g. hook-shaped (then the cable or pipe 28 is not clamped but only inserted or it could be provided that only one of the legs of the spring clamps shown is spring-loaded.

If the cable is aligned as desired, the cable or pipe can be fastened to the holding foot 2 using the fastening device.

This is possible in a particularly simple way, if necessary even without tools. For this purpose, the bracket fastener fastening device has a first bracket 61 and a second bracket 62 articulated to the holding foot 2 (via the stand 3) via a joint 23. The free end of the second bracket 62 carries the opening 9 of the bracket fastener 7, and can be moved over the free end 8 of the first bracket 61 by applying pressure to the second bracket 62, and can thus be locked by the bracket fastener 7.

The free end 8 of the first bracket 61 a here designed with a tapering 18 to facilitate the insertion into the opening 9. For the same purpose, opening 9 of the bracket fastener 7 has two insertion chamfers 91, 92.

The pressure con be exerted without tools, for example, by applying one hand. According to the invention, a clamping aid 15 is provided, which provides a defined point of application. This can be done either manually (e.g. using a thumb) or using a tool (e.g. with a defined torque).

Of course, more than one joint 23 could also be provided. The joint 23 could be designed in another form e.g. as axial joint.

It is preferably provided that the joint 23, via which the second bracket 62 is connected to the holding foot 2, is designed as an elastic or plastic joint 23. With such a joint 23, the pivotability of the second bracket 62 is ensured by a local weakening of the cross-section of the second bracket 62 in the area of the joint 23 and the material properties of the bracket 62 itself.

The bracket fastener 7 can, for example, be designed so that at the free end 8 of the first bracket 61, a rippled surface is arranged, which interacts with a locking lug arranged in the opening 9 of the bracket fastener. Alternatively, at least one hole could be arranged on the first bracket 61, into which a pin arranged in opening 9 of the bracket fastener can be pressed. Alternatively, it could also be provided that the free end 8 of the first bracket 61 is designed without rippled surface, hole or the like, and that a limited movable element (e.g., wedge-shaped or spherical) is arranged in opening 9 of the bracket fastener, through which self-locking locking takes place after the free end 8 of the first bracket 61 has been inserted into opening 9.

In FIGS. 7 to 9 in particular, a device provided in this embodiment for attaching a non-combustible safety strap 11 to the holding device 1 can be recognised irrespective of whether the holding device 1 is mounted to a ground. The device for attaching the safety strap 11 is provided in addition to the fastening device for the cable or pipe 28. In the event of fire, the non-combustible safety strap 11 forms a fall protection for the cable or pipe 28, which prevents the cable or pipe from falling even if the holding foot 2, the stand 3 and the fastening device are destroyed. The device for attaching the safety strap 11 allows a defined course of the safety strap 11 along the holding device 1, and thus facilitates—preferably without tools—the fastening of the safety strap 11 to itself.

In the embodiment shown, the device for attaching the safety strap 11 comprises two retaining clamps 20 (if necessary, only one retaining clamp 20 or more than two retaining clamps 20 could also be provided) and a recess 22 arranged on the mounting side 4 of the holding foot 2 (this is not absolutely necessary). Furthermore, a guide 19 for the safety strap 11 is provided, which is particularly visible in FIG. 1. An insertion aid 17 for safety strap 11 may also be provided.

The holding device 1 is preferably pre-assembled with the safety strap 11. The safety strap 11 is embodied in two parts as shown in FIGS. 7 and 8. The first section is arranged in the area of the holding foot 2, and is connected to the second, here V-shaped section, which runs in the area of the stand 3. The first section has openings aligned with the fastening openings 12, 13 of the holding foot 2, so that the non-combustible safely strap 11 and the holding foot 2 can be fastened simultaneously. The two free ends of the second section (one end of which is provided with a strap closure 10) are connected with each other after the cable or pipe 28 has been arranged, and would hold the cable or pipe 28 securely to the ground in the event of a failure of the bracket fastener (e.g. in the event of fire).

An alternative embodiment of the non-combustible safety strap 11 in one piece form is shown in FIG. 3.

The safety strap 11 is inserted into the recess 22 and the retaining clamps 20 even before mounting the holding device 1 to the ground and before pre-fixing the cable or pipe 28. The safety strap 11 is already correctly aligned and held relative to the holding device 1.

Then the holding device 1 is mounted to the ground. Then the cable or pipe 28 is prefixed. Then the safety strap 11 is guided around the cable or pipe 28, guided through the guide 19, and exits at the other side of the stand 3 via an outlet opening 24. In the area of the outlet opening 24 the safety strap 11 has a passage opening 25, so that the free end of the safety strap 11 can be connected to itself in this area. In this state, the safety strap 11 forms a loop surrounding the cable or pipe 28. Alternatively, the free end of the safety strap 11 could be hooked into the side of the safety strap 11. For the connection, the free end of the safety strap 11 in this embodiment has a claw-shaped design 26. The claws of the tree end can reach behind the safety strap 11 in the area of the passage opening 25 (see FIG. 9b and 9c). Another embodiment of the connection (e.g. gluing, riveting, etc.) would be imaginable.

The passage opening 25 may have a widening to facilitate the insertion of the claws, with a slot-shaped section following the widening. It may be provided that the widening can be closed by a bendable safety lug 27 when the claw is in the slot-shaped section.

In the embodiment shown, safety strap 11 has a prefabricated angled shape.

Openings (here on the angled leg) are provided, which are aligned with the first and second fastening openings 12, 13 arranged on holding foot 2, for a passage of the fastening means.

If the safety strap 11 is to be galvanically separated from the fastening means, sleeves or washers made of an insulating material can be arranged in the area of the openings of the safety strap 11, which allow the fastening means to pass through. These can be embodied in one piece with the holding foot 2. Alternatively, the sleeves or washers can be inserted.

The non-combustible safety strap 11 can—as is known per se—consist of metal or ceramics, for example.

FIG. 9a and 9b show a safety strap 11, as it is prefabricatedly provided to the fitter. FIGS. 9c, 9d and 9e show the completely mounted safety strap 11 in different views with the holding device 1 blanked out.

In the embodiments shown, the safety strap 11 runs with a distance to the cable or pipe 28 formed by the material of the holding device 1, which is particularly advantageous when using a metallic safety strap 11 and the cable is designed as a radiating cable, because this reduces interference of the radiation of the radiating cable by the metallic safety strap 11.

The fixing device for the cable or pipe 28 can have at least one positioning groove 16 for positioning the cable or pipe correctly on the holding device 1, if the cable or pipe 26 is provided with at least one positioning bead.

A first exemplary mounting procedure without using a metallic safety strap 11 is shown in FIG. 10a-f. It can be seen how the cable or pipe 28 to be fastened is first held by the pre-fixing 14 before the bracket fastener 7 is closed by applying pressure to the clamping aid 15.

A second exemplary mounting procedure using a metallic safety strap 11 is shown in FIG. 11a-j. The metallic safety strap 11 used here has a double-sided toothed section at its free end, which can easily be bent over. After inserting the free end into the passage opening 25, the free end is bent over to prevent the free end from slipping out of the passage opening 25. The two teeth located in the area of the passage opening 25 are thus aligned transversely to the passage opening 25 (cf. FIG. 11j), and lock the free end of the metallic safety strap 11 relative to the passage opening 25.

The constructive measures shown together in the figures can also be provided independently of one another or in any combination.

### LIST OF REFERENCE SIGNS

1 holding device

2 holding foot

3 stand

31, 32 longitudinal struts of the stand

33 cross struts of the stand

4 mounting side

5 side facing away from the mounting side

61 first bracket of the bracket fastener

62 second bracket of the bracket fastener

7 bracket fastener

8 free end of the first bracket

9 opening of the bracket fastener

91 insertion chamfer of the opening of the bracket fastener

92 insertion chamfer of the opening of the bracket fastener

10 strap closure of the safety strap

11 non-combustible safety strap

12 first fastening opening

13 second fastening opening

14 pre-fixing

15 clamping aid

16 positioning groove

17 insertion aid for safety strap

18 tapering of the first bracket

19 guide for safety strap

20 retaining damps for safety strap

21 mounting for positioning pin

22 recess for safety strap

23 joint

24 outlet opening

25 passage opening at the safety strap

26 claw-shaped design of the fastening strap

27 safety lug

28 cable or pipe

1. Holding device for a cable or pipe, comprising:
a holding foot for mounting the holding device to a ground
a fastening device arranged on the holding foot for fastening the cable or tube to the holding foot, which has a first bracket and a second bracket, which are lockable together by a bracket fastener, a free end of the first or second bracket being insertable into an opening of the bracket fastener
a joint connecting the second bracket with the holding foot or arranged in the second bracket, wherein
the second bracket carries the opening of the bracket fastener and the opening of the bracket fastener is movable over the free end of the first bracket by applying pressure to the second bracket and is lockable by the bracket fastener, wherein
a clamping aid is arranged above the opening of the bracket fastener in order to provide a defined point of application for exerting pressure on the second bracket.

2. Holding device according to claim 1, wherein the damping aid is formed as a wedge tapering in the direction of the second bracket.

3. Holding device according to claim 1, wherein the opening of the bracket fastener is formed going through.

4. Holding device according to claim 1, wherein the joint is designed as an elastic or plastic joint.

5. Holding device according to claim 1, whereby one free end of the first bracket (61) is formed with a tapering.

6. Holding device according to claim 1, wherein the opening of the bracket fastener has at least two insertion chamfers.

7. Holding device for a cable or pipe, comprising:
a holding foot for mounting the holding device to a ground, the holding foot having a mounting side facing the ground and a side facing away from the ground.
a fastening device for fastening the cable or pipe to the holding foot
a stand arranged on the holding foot, which distances the fastening device for fastening the cable or pipe from the holding foot in a direction normal to the side facing away from the mounting side
the stand being arranged on a lateral edge region of the holding foot so that the side of the holding foot facing away from the mounting side next to the stand is at least partially accessible in the direction normal to the side facing away from the mounting side even when the cable or pipe is fastened by the fastening device, whereby a pre-fixing for the cable or pipe different from the fastening device is provided.

8. Holding device according to claim 7, wherein the stand is designed in the form of a truss.

9. Holding device according to claim 7, wherein the stand is of plate-shaped design.

10. Holding device for a cable or pipe, comprising:
a holding foot for mounting the holding device to a ground
a fastening device arranged on the holding foot for fastening the cable or pipe to the holding foot,
a non-combustible safety strap for the cable or pipe in addition to the fastening device
the holding device comprising a device for attaching to the holding device a non-combustible safety strap for the cable or pipe provided in addition to the fastening device, independently of mounting the holding device to the ground.

11. Holding device according to clam 10, wherein the safety strap is connectable to itself, for forming a loop around a cable or pipe connected to the holding foot by the fastening device.

12. Holding device according to claim 11, wherein tho safety strap has a passage opening into which a free end of the safety strap can be inserted, whereby it is preferably provided that the free end of the safety strap has a claw-shaped design, and the claws of the free end reach behind the safety strap in the area of the passage opening.

13. Holding device according to claim 12, wherein the passage opening has a widening for facilitating the insertion of the claws, whereby a slot-shaped section follows the widening, whereby it is preferably provided that the widening can be closed by a bendable safety lug.

14. Holding device according to claim 12, wherein the safety band is galvanically isolated from fastening means connecting the holding device to a ground.
